(19) United States
(12) Patent Application Publication
(10) Pub. No.: US 2006/0077316 A1
(43) Pub. Date: Apr. 13, 2006

(54) Polarization optical devices and liquid crystal display modules utilizing the same

(75) Inventors: Zen-Yuan Chi, Yuli Township (TW); Yung-Shou Chen, Lujhu Township (TW); Chung-Cheng Kao, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/030,640

(22) Filed: Jan. 6, 2005

(30) Foreign Application Priority Data
Oct. 7, 2004 (TW) 93130365

(51) Int. Cl. G02F 1/1335

(52) U.S. Cl. 349/65

(57) ABSTRACT

A liquid crystal display module and a polarization optical device thereof. A thinfilm is disposed on a first prism, and includes a first refractive layer and a second refractive layer. The refractive index of the first refractive layer is different from that of the second refractive layer; therefore, a light from the first prism is divided into an S-ray and a P-ray. The S-ray is reflected back to the first prism by the thinfilm, thus preventing absorption by a polarizer. A second prism is disposed on the thinfilm. The P-ray is transmitted to the second prism from the thinfilm.

### BACKGROUND

The invention relates to polarization optical devices, and in particular, to polarization optical devices capable of enhancing brightness of liquid crystal display modules.

FIG. 1 depicts a conventional liquid crystal display module 1 of a TFT-LCD. The liquid crystal display module 1 comprises a liquid crystal panel 10 and a backlight module 20. The liquid crystal panel 10 comprises two polarizers 11. The backlight module 20 comprises a prism 21, an optical film 22, a light guide plate 23, a reflector 24, and a light source 25. The prism 21 condenses light from the light source 25.

In the liquid crystal display module 1, fifty percent of the light from the light source 25 is absorbed by the polarizers 11, thus deteriorating brightness thereof.

3M Company provides a dual brightness enhancement film (DBEF) to enhance brightness of the liquid crystal display module. The DBEF comprises about six hundred to eight hundred layers of birefringent films, manufactured by extending thinfims. In the liquid crystal display module, the DBEF takes the place of the optical film 22 to reflect S-rays of the light back to the light guide plate 23 to be re-utilized. Note that if the S-ray reaches to the liquid crystal panel 10, it is absorbed by the polarizers 11.

Additionally, other brightness enhancement films are also disclosed in U.S. Pat. No. 5,965,247, U.S. Pat. No. 6,707,611, and U.S. Pat. No. 6,671,452.

### SUMMARY

A polarization optical device is provided. An exemplary embodiment of a polarization optical device comprises a thinfilm, a first prism, and a second prism. The thinfilm comprises an upper surface, a lower surface, a first refractive layer, and a second refractive layer. The refractive index of the first refractive layer is different from that of the second refractive layer. The first prism is disposed on the lower surface of the thinfilm to abut the first refractive layer. The second prism is disposed on the upper surface of the thinfilm. The first and second prisms are symmetrical with respect to the thinfilm. Light from the first prism is divided into an S-ray and a P-ray by the thinfilm. The S-ray is reflected to the first prism by the thinfilm. The P-ray is transmitted to the second prism from the thinfilm.

The refractive index of the first refractive layer may be larger or less than that of the second refractive layer. The first and second refractive layers are homogeneous material.

Furthermore, the first prism is formed in a manner such that an incident angle of the light from the first refractive layer to the second refractive layer is a Brewster angle. The second prism is formed in a manner such that the light from the second refractive layer is deflected substantially in a direction normal to the upper surface of the thinfilm.

Moreover, the thickness of the refractive layer is derived from an equation of T=λo/4n, wherein T is the thickness of the refractive layer, λo is a center wavelength of the light, and n is the refractive index of the refractive layer.

Additionally, the refractive index of the first prism is about 1.52 to 1.65. The refractive index of the first refractive layer is about 2.0 to 2.2. The refractive index of the second refractive layer is about 1.38 to 1.5. The first and second refractive layers are disposed alternately in the thinfilm. The number of each of the first and second refractive layers is about three to six. A vertex angle of the first prism is 56 degrees.

A liquid crystal display module is also provided. An exemplary embodiment of a liquid crystal display module comprises a backlight module and a liquid crystal panel disposed on the backlight module. The backlight module comprises a thinfilm, a first prism, and a second prism. The thinfilm comprises an upper surface, a lower surface, a first refractive layer, and a second refractive layer. The refractive index of the first refractive layer is different from that of the second refractive layer. The first prism is disposed on the lower surface of the thinfilm to abut the first refractive layer. The second prism is disposed on the upper surface of the thinfilm. The first and second prisms are symmetrical with respect to the thinfilm. A light from the first prism is divided into an S-ray and a P-ray by the thinfilm. The S-ray is reflected to the first prism by the thinfilm. The P-ray is transmitted to the second prism from the thinfilm, and is deflected substantially in a direction normal to the upper surface of the thinfilm by the second prism for transmission to the liquid crystal panel.

### DESCRIPTION OF THE DRAWINGS

Polarization optical devices and liquid crystal display modules can be more fully understood by reading the subsequent detailed description and examples with references made to the accompanying drawings, wherein:

FIG. 1 is a schematic view of a conventional liquid crystal display device;

FIG. 2 is a schematic view of an embodiment of a liquid crystal display device;

FIG. 3 is a schematic view of an embodiment of a polarization optical device;

FIG. 4 is a schematic view depicting part of a first prism and a thinfilm in FIG. 3; and

FIG. 5 is a diagram of spectrum simulation.

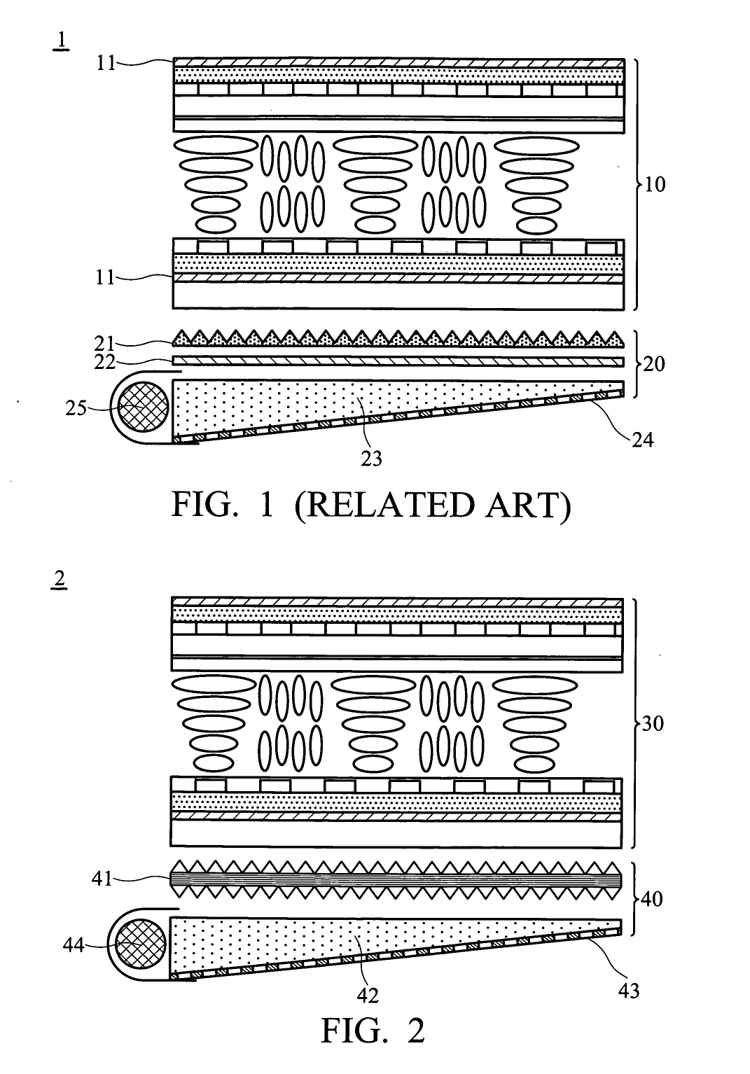

### DETAILED DESCRIPTION

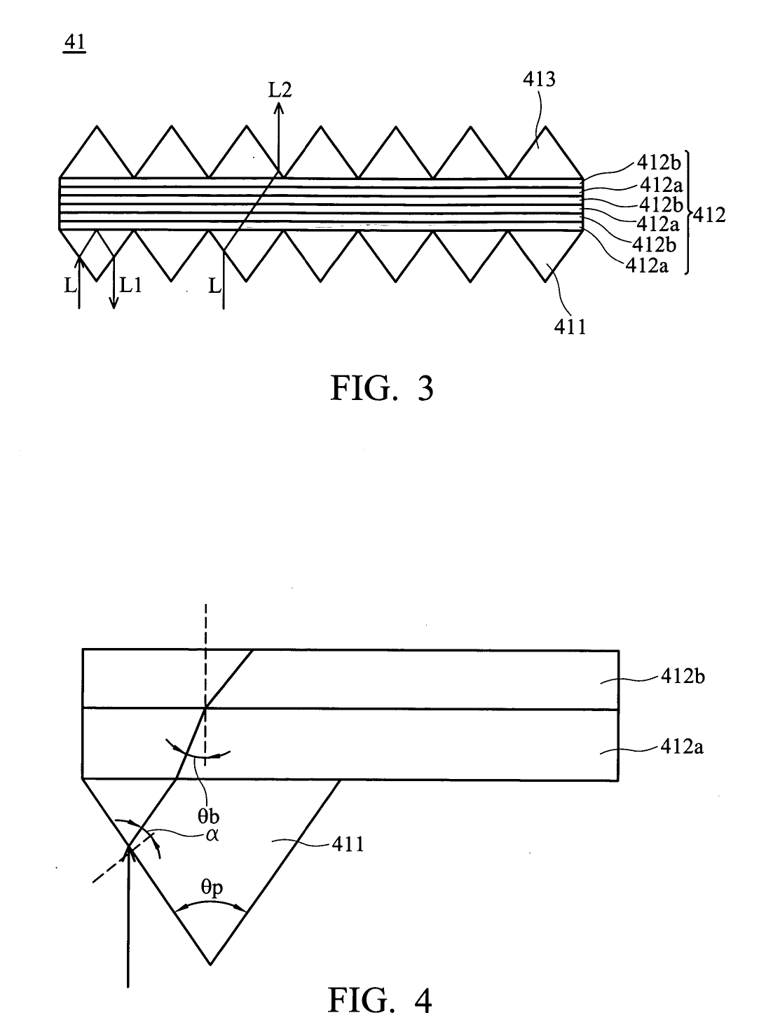

FIG. 2 depicts an embodiment of a liquid crystal display module 2. An embodiment of the liquid crystal display module 2 comprises a backlight module 40 and a liquid crystal panel 30 disposed on the backlight module 40. The backlight module 40 comprises a polarization optical device 41, a light guide plate 42, a reflector 43, and a light source 44. Additionally, the liquid crystal display module 2 further comprises other devices. Such devices are not directly related to this embodiment, and detailed description thereof is thus omitted.

An embodiment of the liquid crystal display module 2 differs from the conventional liquid crystal display module 1 in that the prism 21 and the optical film 22 in the conventional liquid crystal display module 1 are replaced by the polarization optical device 41 in the liquid crystal display module 2 of this embodiment.

FIG. 3 is a schematic view of an embodiment of the polarization optical device 41. An embodiment of the polarization optical device 41 comprises a thinfilm 412, a first prism 411, and a second prism 413. The thinfilm 412 is disposed on the first prism 411, and comprises a plurality of first refractive layers 412a and a plurality of second refractive layers 412b. In FIG. 3, the number of each of the first and second refractive layers 412a and 412b is three. The first and second refractive layers 412a and 412b are disposed alternately in the thinfilm 412. The refractive index of the first refractive layer 412a is different from that of the second refractive layer 412b. Thus, a light L from the first prism 411 is divided into an S-ray L1 and a P-ray L2 by the thinfilm 412. The S-ray L1 is reflected back to the first prism 411 by the thinfilm 412. The P-ray L2 is transmitted to the liquid crystal panel 30 via the second prism 413 from the thinfilm 412.

Note that the first and second refractive layers 412a and 412b are homogeneous material. That is, the refractive index is identical in the same refractive layer.

As shown in FIG. 3, the first and second prisms 411 and 413 are symmetrical with respect to the thinfilm 412. The first prism 411 is disposed on the lower surface of the thinfilm 412 to abut the first refractive layer 412a at the bottom. Furthermore, the first prism 411 is formed in a manner such that an incident angle of the light L from the first refractive layer 412a to the second refractive layer 412b is a Brewster angle. Thus, the light L from the first prism 411 is divided into the S-ray L1 and the P-ray L2 by the thinfilm 412.

The second prism 413 is disposed on the upper surface of the thinfilm 412 to abut the second refractive layer 412b at the top. Furthermore, the second prism 413 is formed in a manner such that the P-ray L2 from the thinfilm 412 is deflected substantially in a direction normal to the upper surface of the thinfilm. That is, the P-ray L2 is vertically transmitted to the liquid crystal panel 30.

In FIG. 4, θb is a Brewster angle such that the light L from the first prism 411 is divided into the S-ray L1 and the P-ray L2. θp is a vertex angle of the first prism 411. α is a refractive angle from the exterior to the first prism 411.

The center wavelength (λo) of the light L is first preset at 680 nm. The refractive index (ns) of the first prism 411 is preset at 1.62. The refractive index (n1) of the first refractive layer 412a is preset at 2.2. The refractive index (n2) of the second refractive layer 412b is preset at 1.38. Then, θb can be obtained by Brewster's law [θb=tan⁻¹(n2/n1)]. θp can be obtained by Snell's law [n1Sin(θb)=nsSin(90−θp/2−α) and nsSin(α)=Sin(90−θp/2)], and is 56 degrees.

Additionally, the thickness of the refractive layer is derived from an equation of T=λo/4n, wherein T is the thickness of the refractive layer. Then, the number of each of the first and second refractive layers 412a and 412b can be obtained by software, and is three.

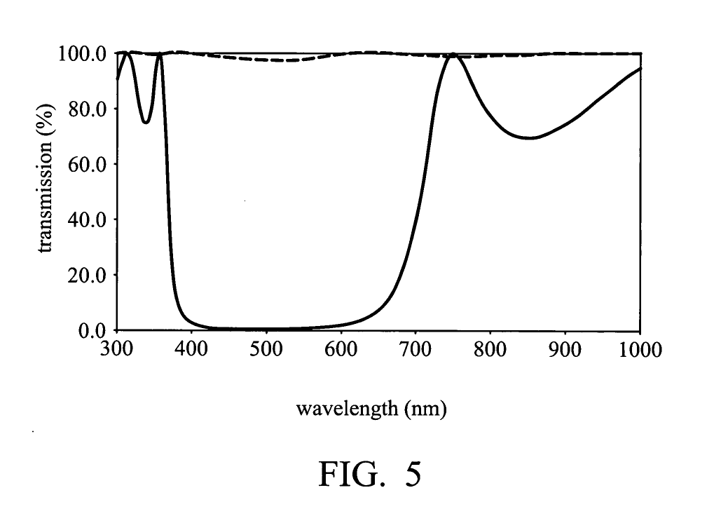

FIG. 5 depicts a spectrum simulation of the polarization optical device in this embodiment, wherein a solid line represents the S-ray, and a dotted line represents the P-ray. In FIG. 5, the transmission of the P-ray is almost 100 percent. Conversely, the reflection of the S-ray at 400-600 nm is almost 100 percent. Note that the wavelength of the light source of the liquid crystal display module is about 400-600 nm.

Furthermore, by means of the above calculation, the refractive index of the first prism 411 may be about 1.52 to 1.65. The refractive index of the first refractive layer 412a may be about 2.0 to 2.2. The refractive index of the second refractive layer 412b may be about 1.38 to 1.5. Preferably, the number of each of the first and second refractive layers 412a and 412b may be about three to six.

Additionally, while the calculation in this embodiment is performed in a manner such that the refractive index of the first refractive layer 412a exceeds that of the second refractive layer 412b, it is not limited thereto. In practice, the refractive index of the first refractive layer 412a may be less than that of the second refractive layer 412b.

As previously described, an embodiment of the polarization optical device comprises the thinfilm and the first prism so that the incident light can be divided into the S-ray and the P-ray by film interference. Additionally, the S-ray can be reflected back to the light guide plate to be re-utilized, thus enhancing brightness.

Furthermore, the S-ray and the P-ray is separated by film interference in this embodiment. Compared with the DBEF comprising 600-800 layers, an embodiment of the polarization optical device simply comprises 6-12 layers.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polarization optical device comprising:
a thinfilm having an upper surface, a lower surface, a first refractive layer, and a second refractive layer, wherein the refractive index of the first refractive layer is different from that of the second refractive layer;
a first prism disposed on the lower surface of the thinfilm to abut the first refractive layer; and
a second prism disposed on the upper surface of the thinfilm, wherein the first and second prisms are symmetrical with respect to the thinfilm.

2. The polarization optical device as claimed in claim 1, wherein the first prism is formed in a manner such that an incident angle of the light from the first refractive layer to the second refractive layer is substantially a Brewster angle.

3. The polarization optical device as claimed in claim 1, wherein the second prism is formed in a manner such that the light from the second refractive layer is deflected substantially in a direction normal to the upper surface of the thinfilm.

4. The polarization optical device as claimed in claim 1, wherein the first and second refractive layers are homogeneous material.

5. The polarization optical device as claimed in claim 1, wherein the thickness of the refractive layer is derived from an equation of T=λo/4n, wherein T is the thickness of the refractive layer, λo is the center wavelength of the light, and n is the refractive index of the refractive layer.

6. The polarization optical device as claimed in claim 1, wherein the refractive index of the first prism is about 1.52 to 1.65, the refractive index of the first refractive layer is about 2.0 to 2.2, and the refractive index of the second refractive layer is about 1.38 to 1.5.

7. The polarization optical device as claimed in claim 6, wherein the first and second refractive layers are disposed alternately in the thinfilm, the number of each of the first and second refractive layers is about three to six.

8. The polarization optical device as claimed in claim 1, wherein the refractive index of the first prism is about 1.62, the refractive index of the first refractive layer is about 2.2, and the refractive index of the second refractive layer is about 1.38.

9. The polarization optical device as claimed in claim 8, wherein a vertex angle of the first prism is about 56 degrees.

10. The polarization optical device as claimed in claim 9, wherein the first and second refractive layers are disposed alternately in the thinfilm, and the number of each of the first and second refractive layers is three.

11. A liquid crystal display module comprising:
a backlight module; and
a liquid crystal panel disposed on the backlight module;
wherein the backlight module comprises:
a thinfilm comprising an upper surface, a lower surface, a first refractive layer, and a second refractive layer, wherein the refractive index of the first refractive layer is different from that of the second refractive layer;
a first prism disposed on the lower surface of the thinfilm to abut the first refractive layer; and
a second prism disposed on the upper surface of the thinfilm, wherein the first and second prisms are symmetrical with respect to the thinfilm.

12. The liquid crystal display module as claimed in claim 11, wherein the first prism is formed in a manner such that an incident angle of the light from the first refractive layer to the second refractive layer is substantially a Brewster angle.

13. The liquid crystal display module as claimed in claim 11, wherein the first and second refractive layers are homogeneous material.

14. The liquid crystal display module as claimed in claim 11, wherein the thickness of the refractive layer is derived from an equation of T=λo/4n, wherein T is the thickness of the refractive layer, λo is the center wavelength of the light, and n is the refractive index of the refractive layer.

15. The liquid crystal display module as claimed in claim 11, wherein the refractive index of the first prism is about 1.52 to 1.65, the refractive index of the first refractive layer is about 2.0 to 2.2, and the refractive index of the second refractive layer is about 1.38 to 1.5.

16. The liquid crystal display module as claimed in claim 15, wherein the first and second refractive layers are disposed alternately in the thinfilm, the number of each of the first and second refractive layers is about three to six.

17. The liquid crystal display module as claimed in claim 11, wherein the refractive index of the first prism is about 1.62, the refractive index of the first refractive layer is about 2.2, and the refractive index of the second refractive layer is about 1.38.

18. The liquid crystal display module as claimed in claim 17, wherein a vertex angle of the first prism is 56 degrees.

19. The liquid crystal display module as claimed in claim 17, wherein the first and second refractive layers are disposed alternately in the thinfilm, and the number of each of the first and second refractive layers is three.
